(19) United States
(12) Patent Application Publication
(10) Pub. No.: US 2025/0128932 A1
(43) Pub. Date: Apr. 24, 2025

(54) SYSTEM AND METHOD FOR CONVEYING AND DISPENSING WATER

(71) Applicant: EFRAIM SHMUEL, JERUSALEM (IL)

(72) Inventor: YOSEF EDRI, JERUSALEM (IL)

(21) Appl. No.: 18/914,354

(22) Filed: Oct. 14, 2024

(30) Foreign Application Priority Data
Oct. 19, 2023 (IL) 307892

(51) Int. Cl. B67D 1/08; B67D 1/00; B67D 1/12

(52) U.S. Cl. CPC B67D 1/0895; B67D 1/0014; B67D 1/1277; B67D 2210/00102

(57) ABSTRACT

A water dispensing system, comprising a hot water tank configured to carry hot water; a water outlet located higher than the hot water tank, said water outlet is configured to output the hot water; a hot water tube configured to carry the hot water traveling from the hot water tank to the water outlet; a pump for pumping the hot water from the hot water tank towards the water outlet, wherein the pump operates in a continuous manner during Shabat day; a valve located between the pump and the water outlet, said valve has an open state in response to a request to supply water, said open state enables passage of the hot water from the hot water tube to the water outlet, said valve has a closed state in which the hot water flows back to the hot water tank.

### FIELD OF THE INVENTION

The subject matter generally relates to dispensing and heating water.

### BACKGROUND OF THE INVENTION

Water dispensers provides available water consumed for drinking, cleaning, and also in industries, for example for sanitation. According to Jewish religious regulations, heating is considered as labor and cannot be done on Saturdays and holidays. However, hot water is still needed, mainly for drinking hot beverages such as tea and coffee.

Some solutions to provide hot water on Saturdays and holidays require constant heating, for example by placing a container on a low-power heating device. The heating device may be connected to the gas grid or to the power grid. This solution consumes a lot of energy and does not consider actual demand. For example, it also provides hot water at night, when most people are asleep.

Other religious regulations forbid people from consuming water which was heated in the same container in which the water is poured to the users' glasses or bowls. Hence, there is a need to heat water in other containers, which are not the containers from which the water is dispensed to the users' cups/bowls/glasses.

### SUMMARY OF THE INVENTION

The subject matter discloses a water dispensing system, comprising a hot water tank configured to carry hot water; a water outlet located higher than the hot water tank, said water outlet is configured to output the hot water; a hot water tube configured to carry the hot water traveling from the hot water tank to the water outlet; a pump for pumping the hot water from the hot water tank towards the water outlet, wherein the pump operates in a continuous manner during Shabat day; a valve located between the pump and the water outlet, said valve has an open state in response to a request to supply water, said open state enables passage of the hot water from the hot water tube to the water outlet, said valve has a closed state in which the hot water flows back to the hot water tank.

In some cases, the water dispensing system further comprises a tube opening having an open position when the hot water is not requested to be outputted, and a closed position, when the hot water is requested to be outputted via the water outlet. In some cases, the tube opening is sealed by a cover, wherein the cover seals the tube opening upon request to dispense the hot water. In some cases, the cover is coupled to a handle, said handle is physically coupled to a mechanical device moved by the user when the user requests hot water. In some cases, the hot water tank comprises a second opening in which water can fall back to the hot water tank from the hot water tube via the tube opening. In some cases, the tube opening is located between the pump and the water outlet.

In some cases, the water dispensing system further comprises an outlet volume located between the valve and the water outlet, wherein the water travels in the outlet volume downwards using gravitation forces to the water outlet. In some cases, the hot water tube comprises an upward sub-tube, in which the hot water flows from the hot water tank towards the controllable valve, and a downward sub-tube, in which the hot water flows from the controllable valve to the hot water tank. In some cases, the pump is configured to pump water from the hot water tank into the upward sub-tube. In some cases, the water is circulated for 5-20 seconds in the upward sub-tube and the downward sub-tube. In some cases, the hot water tank comprises a sensor for detecting an amount of water in the hot water tank.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a water dispenser having a hot water tank and a cold water tank located below the water outlet, according to exemplary embodiments of the invention;

FIG. 2 shows a water dispenser having a hot water tube of a double configuration, capable of circulating hot water and dispensing hot water, according to exemplary embodiments of the subject matter;

FIG. 3 shows a water dispenser having a hot water tube of a single configuration, capable of circulating hot water and dispensing hot water, according to exemplary embodiments of the subject matter.

### DETAILED DESCRIPTION

The subject matter described herein discloses a system for conveying and dispensing water. The system comprises a hot water tank comprising hot water and a pump configured to pump the hot water from the hot water tank to a hot water tube towards a water outlet located above the hot water tank. That is, the system is used when the hot water cannot be conveyed solely using gravitational forces. The system may be used when the hot water tank is located in a cabin or on the floor, lower than the water outlet. The system can be coupled to a tab placed above a sink. The system may also comprise a cold water tank, a lukewarm water tank (at near-room temperature), multiple water tanks of each type—hot/cold/lukewarm—and the like.

The system comprises a controllable valve located on the hot water tube between the pump and the water outlet. The controllable valve is configured to enable or disable the flow of water from the hot water tube to the water outlet. The controllable valve may move in response to moving a component in the water dispenser system, such as a case in which a user of the water dispenser presses a mechanical handle when requesting dispensing of hot water. The controllable valve may be physically coupled to the mechanical handle, moving in response to the movement of the handle by the user. The water in the hot water tank is heated during Shabat using a heater. The heater's operation may be selected by a person skilled in the art. The heater may be coupled to a power source, such as a battery, the electrical grid, and the like. The pump circulates water from the hot water tank via the hot water tube and back to the hot water tank, to prevent “cooking” of the water on a Shabbat day. When the user requests hot water, the controllable valve moves and the hot water flows from the hot water tube to the hot water outlet.

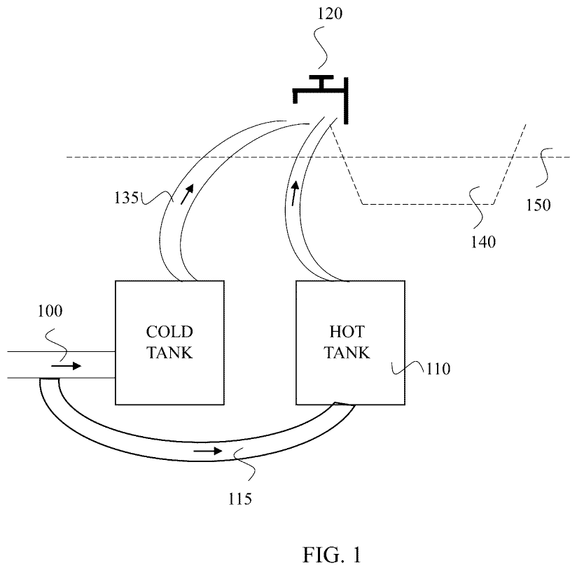

FIG. 1 shows a water dispenser having a hot water tank and a cold water tank located below the water outlet, according to exemplary embodiments of the invention. The hot water tank 110 and the cold water tank 115 may be placed inside a housing or mounted on a surface, such as a shelf or floor. The housing may be sealed to prevent access to the components located therein. The housing may have a base, sidewalls and a top cover.

The hot water tank 110 and the cold water tank 115 may be connected to a pressurized water source, such as a water grid 100, such that when the amount of water in one of the tanks 110, 115 is lower than a threshold, water flows into the relevant tank. The hot water tank 110 and the cold water tank 115 may comprise sensors for detecting the amount of water in the relevant tank, for example using a floater. The hot water tank 110 and the cold water tank 115 may include additional sensors, for example for measuring biological, chemical or physical properties of the water, such as an amount or concentration of a material in the water. The hot water tank 110 and the cold water tank 115 may comprise filters configured to filter materials from the water grid 100.

The water dispenser may comprise a control panel (not shown) used by persons to input commands on non-shabbat days. The control panel may comprise buttons, knobs, or a touch-operated input unit used to input commands into the water dispenser 100. The commands may include requests for cold water, lukewarm water, hot water, requests for various amounts of water, and the like. In Shabbat days, the users will move a non-electronic device, such as a handle, when requesting for water. In response to moving the non-electronic device, water will flow from the relevant tank upwards, to the water outlet 120. In some cases, the water outlet 120 may be a tap dispensing water into a sink 140. The upper section of the sink 140 may be substantially at the height of a kitchen top 150.

In some cases, the water may be conveyed into the water outlet 120 via two separate tubes, one from each tank. That is, hot water is conveyed from the hot water tank 110 to the water outlet 120 via hot water tube 130 and cold water is conveyed from the cold water tank 115 to the water outlet 120 via cold water tube 135. While cold water may remain in the cold water tube during Shabbat days until being dispensed, it is desired not to store the hot water in the hot water tube 130 to prevent the hot water from being cooled, as the hot water tube is not heated, such that when the cooled hot water is brought back to the hot water tank 110, the cooled hot water is heated, which is forbidden according to some religious regulations. As such, it is desired to use the controllable valve in order to allow the hot water to be circulated in the hot water tube 135 from the hot water tank 110 and back to the hot water tank 110, depending on the position of the controllable valve. One position of the controllable valve conveys the hot water to the water outlet 120 and a second position of the controllable valve conveys the hot water to the hot water tank 110.

The water dispenser 100 may also comprise a controller for controlling the heating process used to heat the water in the water tank 120. In some cases, the controller may receive commands from a remote device, such as an online server. The controller may be coupled to a memory storage used to store information. Such information may include a set of rules used by the controller to control the heating process, prior usage of the water dispenser 100, and the like.

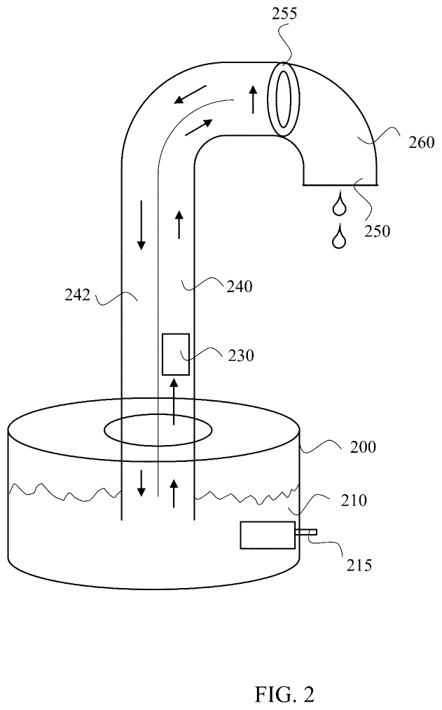

FIG. 2 shows a water dispenser having a hot water tube of a double configuration, capable of circulating hot water and dispensing hot water, according to exemplary embodiments of the subject matter. The double configuration is defined as an embodiment in which the hot water tube comprises an upward sub-tube 240, in which the hot water flows from the hot water tank 200 towards the controllable valve 255, and a downward sub-tube 242, in which the hot water flows from the controllable valve 255 to the hot water tank 200.

The water dispenser comprises a pump 230 configured to pump water 210 from the hot water tank 200 into the upward sub-tube 240. The pump 230 may be a centrifugal pump, a diaphragm pump, a piston pump and the like.

Once the water 210 is already in the upward sub-tube 240, additional water pumped from the hot water tank 200 pushes the previously pumped water upwards, until reaching the controllable valve 255. In case the controllable valve 255 is in an open position, the hot water flows via outlet volume 260 towards the water outlet 250. It is desired that no water remains in the outlet volume 260, so the controllable valve 255 is substantially located in a manner that assures that all the water in the outlet volume 260 can only flow downwards, towards the water outlet 250. The outlet volume 260 is defined as the space between the controllable valve 255 and the water outlet 250.

In case the controllable valve 255 is in a closed position, the hot water flows to the downward sub-tube 242 to the hot water tank 200. In some exemplary embodiments, when the controllable valve 255 is in the closed position, the water is circulated for 5-20 seconds in the upward sub-tube 240 and the downward sub-tube 242, such that the water temperature remains substantially the same, and there is no heating process when the water returns to the hot water tank 200. The hot water tank 200 may include a sensor 215 for detecting the amount of water in the hot water tank 200, the sensor 215 may be a floater.

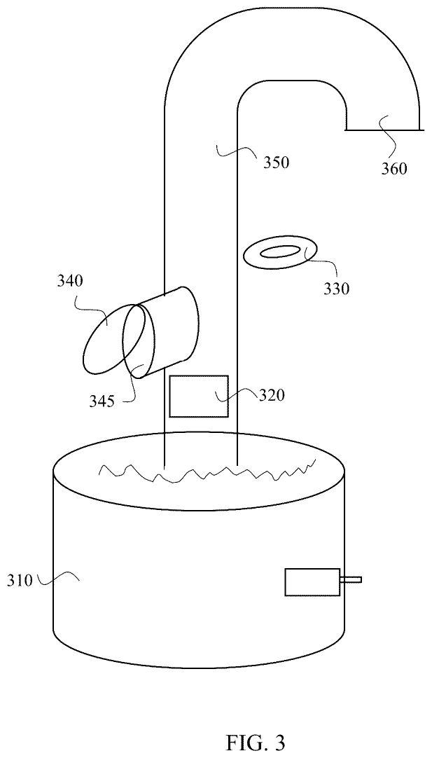

FIG. 3 shows a water dispenser having a hot water tube of a single configuration, capable of circulating hot water and dispensing hot water, according to exemplary embodiments of the subject matter. In the single configuration, the water falls back from the tube 350 via a tube opening 345. The tube opening 345 is located between the pump 320 and the water outlet 360, in the hot water tube 350. The tube opening 345 has an open position when the hot water is not requested to be outputted, and a closed position, when the hot water is requested to be outputted via the water outlet 360. When the tube opening 345 is in the closed position, water keeps moving upwards until it reaches the water outlet 360, from which the water is dispensed.

The tube opening 345 may be sealed by a cover 340. The cover 340 may be coupled to a handle 330, said handle 330 moves the cover 340 to seal the tube opening 345 upon request to dispense the hot water. The handle 330 may be physically coupled to the mechanical device moved by the user. The single configuration requires a second opening in the hot water tank 310, from which water can fall back to the hot water tank. The second opening is defined as an opening in addition to the hot water tube 350.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the invention. To the extent that section headings are used, they should not be construed as necessarily limiting.

What is claimed is:

1. A water dispensing system, comprising:
a hot water tank configured to carry hot water;
a water outlet located higher than the hot water tank, said water outlet is configured to output the hot water;
a hot water tube configured to carry the hot water traveling from the hot water tank to the water outlet;
a pump for pumping the hot water from the hot water tank towards the water outlet, wherein the pump operates in a continuous manner during Shabat day;
a valve located between the pump and the water outlet, said valve has an open state in response to a request to supply water, said open state enables passage of the hot water from the hot water tube to the water outlet, said valve has a closed state in which the hot water flows back to the hot water tank.

2. The water dispensing system of claim 1, further comprises a tube opening having an open position when the hot water is not requested to be outputted, and a closed position, when the hot water is requested to be outputted via the water outlet.

3. The water dispensing system of claim 2, wherein the tube opening is sealed by a cover, wherein the cover seals the tube opening upon request to dispense the hot water.

4. The water dispensing system of claim 3, wherein the cover is coupled to a handle, said handle is physically coupled to a mechanical device moved by the user when the user requests hot water.

5. The water dispensing system of claim 2, wherein the hot water tank comprises a second opening in which water can fall back to the hot water tank from the hot water tube via the tube opening.

6. The water dispensing system of claim 2, wherein the tube opening is located between the pump and the water outlet.

7. The water dispensing system of claim 1, further comprises an outlet volume located between the valve and the water outlet, wherein the water travels in the outlet volume downwards using gravitation forces to the water outlet.

8. The water dispensing system of claim 1, wherein the hot water tube comprises an upward sub-tube, in which the hot water flows from the hot water tank towards the controllable valve, and a downward sub-tube, in which the hot water flows from the controllable valve to the hot water tank.

9. The water dispensing system of claim 8, wherein the pump is configured to pump water from the hot water tank into the upward sub-tube.

10. The water dispensing system of claim 8, wherein the water is circulated for 5-20 seconds in the upward sub-tube and the downward sub-tube.

11. The water dispensing system of claim 1, wherein the hot water tank comprises a sensor for detecting an amount of water in the hot water tank.
